(19) United States
(12) Patent Application Publication
(10) Pub. No.: US 2021/0076718 A1
(43) Pub. Date: Mar. 18, 2021

(54) Natural Sweetener Composition

(71) Applicant: Loren Miles, Encino, CA (US)

(72) Inventors: Loren Miles, Encino, CA (US); Gina Rapo, Encino, CA (US)

(73) Assignee: Loren Miles, Encino, CA (US)

(21) Appl. No.: 17/067,634

(22) Filed: Oct. 9, 2020

Related U.S. Application Data
(60) Provisional application No. 62/884,969, filed on Aug. 9, 2019.

(51) Int. Cl. A23L 27/30; A23L 27/12

(52) U.S. Cl. CPC A23L 27/33; A23V 2002/00; A23L 27/12

(57) ABSTRACT

Sweetener composition for the primary use in beverages and food products where the taste and qualities of cane sugar are nearly identical, in one implementation includes beet sugar derived isomaltulose and monk fruit extract. In particular, the natural sweetener composition includes: about 90 to about 99 composition weight percent of beet sugar derived isomaltulose and about 1 to about 10 composition weight percent of monk fruit extract. In another implementation, a natural sweetener composition includes an appropriate blend of a beet sugar derived isomaltulose, beet sugar and monk fruit extract. In particular, the natural sweetener composition includes beet sugar derived isomaltulose, beet sugar and monk fruit extract. In particular, the natural sweetener composition includes: about 40 to about 90 composition weight percent of beet sugar derived isomaltulose, about 10 to about 50 composition weight percent beet sugar and about 1 to about 10 composition weight percent of monk fruit extract.

### RELATED APPLICATION

This application claims the benefit of U.S. Provisional Application Ser. No. 62/884,969 filed 9 Aug. 2019 under 35 U.S.C. 119(e).

### FIELD

The present disclosure relates to natural sweetener compositions. More specifically, the present disclosure relates to a zero- or low-calorie natural sweetener composition including a combination of one or more low-calorie disaccharide derived from beet sugar (isomaltulose), beet sugar, and/or monk fruit extract. The natural sweetener compositions are intended to be used in beverages, foods and/or food and beverage products to replace or reduce high-calorie sweetener content such as sucrose.

### BACKGROUND

High-fructose corn syrup, artificial sweeteners, sugar, obesity and diabetes are today's biggest health concerns. Health officials and scientists are beginning to understand in particular the link with high-fructose corn syrup, artificial sweeteners and sugar products to obesity, diabetes and numerous other health concerns. The average American is estimated to consume 20 teaspoons a day or more than 150 pounds of sugar per year. Teen consumption is higher at 34 teaspoons of sugar a day. Excessive consumption of sugar, especially by American youth, has experts calling the recent dramatic rise in type 2 diabetes among adolescents an “emerging epidemic.” Further, as a result of excessive refining, sugar is “devoid of vitamins, minerals and fiber.” Accordingly, the statistics are staggering; 129 million adult Americans are overweight, over 60 million, or over 30% of the adult population, are obese. As a result of these health conditions, there are over 300,000 premature deaths each year. Over 40 million children, including “tweens” and teens are overweight. Many health experts assert that sugar is nutritionally empty and detrimental to human health and many believe sugar would fail the FDA approval process if such a hypothetical attempt were made today. According to Dr. Robert C. Atkins, founder of the popular Atkins diet, “sugar has no nutritional value and is directly harmful to your health. Despite vociferous attempts to defend sugar, there are studies that clearly show how harmful (and even deadly in the case of diabetics) the effects of sugar can be.” According to Nancy Appleton, PhD, author of “Lick the Sugar Habit,” there are 78 metabolic consequences of consuming sugar.

Diabetes however, is really only one of the numerous consequences of over-consuming sugar. Dr. John Yudkin, a leading authority on dietary sugars, says that the detrimental effects of excess sugar in the diet go far beyond rotting teeth and obesity. “For example,” Yudkin says, “Sugar causes irregularities in the insulin response; Sugar causes diabetes-like damage to the kidneys; sugar contributes to degeneration of the retina; sugar raises blood fat levels and sugar increases the stickiness of the blood platelets, a common precursor of heart trouble.”

The most effective way to achieve and sustain healthful weight-loss is by reducing calorie intake. Unfortunately, most humans instinctively are attracted to the sensation of sweetness which makes resisting eating foods and beverages which contain high-caloric, high-glycemic sugars and sweeteners more difficult, such as, for example, sucrose, fructose, honey and high-fructose corn syrup. Further, food manufacturers that produce low-or reduced-fat products often substantially increase the sugar or sweetener content of their products to offset the loss of taste and texture often associated with reducing fat content.

One avenue in an attempt to solve these serious health issues is the creation of a zero- or low-calorie sweetener or sugar substitutes that can be used in foods and/or beverages to replace or reduce high-calorie sweeteners and/or sugar content. Examples of such zero-calorie artificial sweeteners include, for example, aspartame, acesulfame-K, sucralose and saccharin. Low-calorie natural sweeteners would include monk fruit (lo han guo) and stevia both derived from fruit and roots, respectively. However, not all zero- or low-calorie sweeteners or sugar substitutes, artificial or natural are suitable for all applications. For example, some sweeteners may be suitable for beverages such as sodas and drink mixes but are not acceptable for use in baked goods because exposure to higher temperatures during baking can reduce the sweetening ability of the sweetener. Some natural sweeteners have a bitter aftertaste and do not render a sweet enough taste or exist in a natural color such as brown or yellow, which conflicts with clear beverages or light-colored baked products. As another example, some sweeteners may be suitable for use in solid foods or baked goods but may not work properly for use in beverages and drink mixes due to limitations on solubility or may not have GRAS status (generally recognized as safe as defined by the FDA).

In light of the aforementioned, there is a clear need and a demand for a natural sweetener composition that meets many of the health and commercial requirements. Specifically, there is a need and an unmet demand for a zero- or low-calorie all-natural sweetener composition that can be utilized in food products such as baked goods, snack foods, dairy products and the like and in beverages and beverage mixes. There is a further need and a demand for a natural sweetener composition which is diabetic safe, tastes like sugar, and includes less than 1 gram of carbohydrates.

### SUMMARY

Certain implementations of the present disclosure include, but are not limited to, providing a (100%) natural sweetener composition.

Some implementations of the present disclosure provide an all natural, zero-or low-calorie natural sweetener composition that may be used in food products and/or beverages to replace or reduce high-calorie sugar or sugar sweetener content.

Some implementations of the present disclosure provide a natural sweetener composition that tastes like sugar, is diabetic safe, includes less than 1 gram of carbohydrates.

Some implementations of the present disclosure provide a natural sweetener composition that tastes like sugar, is compatible with a ketogenic diet, and includes less than 1 gram of carbohydrates.

Some implementations of the present disclosure can be attained, at least in part, through a natural sweetener composition including a low-calorie disaccharide derived from beet sugar (isomaltulose), beet sugar and monk fruit extract, to provide an organoleptic sensation nearly identical to that of cane sugar (sucrose).

In accordance with certain preferred implementations, the natural sweetener composition includes a low-calorie disaccharide derived from beet sugar (isomaltulose), beet sugar, and monk fruit extract.

In accordance with certain other preferred implementations, the natural sweetener composition delivers an organoleptic sensation nearly identical to that of cane sugar (sucrose) and includes about 65 to about 75 composition weight percent of beet sugar derived isomaltulose, about 20 to about 30 composition weight percent beet sugar and an about 1 to about 10 composition weight percent of monk fruit extract.

In accordance with certain other preferred implementations of the disclosure, the natural sweetener composition includes about 71.4 composition weight percent of beet sugar derived isomaltulose, about 25 composition weight percent beet sugar and about 3.6 composition weight percent of monk fruit extract.

In accordance with certain other preferred implementations, the natural sweetener composition delivers an organoleptic sensation nearly identical to that of sucrose and includes about 90 to about 99 composition weight percent of beet sugar derived isomaltulose, and a 1 to about 10 composition weight percent of monk fruit extract.

In accordance with another further preferred implementation of the disclosure, the natural sweetener composition includes about 97.3 composition weight percent of beet sugar derived isomaltulose and about 2.7 composition weight percent of monk fruit extract.

Previous attempts to solve the solve the above-mentioned problems have generally failed to provide a zero- or low- calorie all natural sweetener composition including a polyol such as erythritol, a reduced- calorie sweetener such as a blend of stevia, monk fruit, oligofructose, fructose, natural flavors, and natural, organic cane sugar (sucrose) that is as effective as desired in satisfying one or more of the above identified needs or demands.

### BRIEF DESCRIPTION OF THE DRAWINGS

FIG. 1 shows exemplary flowchart 100 illustrating the blending of a natural sweetener composition, according to one implementation of the present disclosure; and

FIG. 2 shows exemplary flowchart 200 illustrating the blending of another natural sweetener composition, according to one implementation of the present disclosure.

### DETAILED DESCRIPTION

A certain implementation of the present disclosure provides a zero- or low-calorie all-natural sweetener composition suitable for use in beverages, food products and/or food products, as the composition is designed to achieve an organoleptic sensation nearly identical to that of cane sugar (sucrose). Such a natural sweetener composition may include a combination of beet sugar derived isomaltulose, beet sugar, and monk fruit extract. In some implementations, the natural sweeteners composition may include beet sugar derived isomaltulose and monk fruit extract. Another certain implementation of the present disclosure further provides a natural sweetener composition having zero or low in calories and may depending on the amount used, contain less than 1 gram of carbohydrates. Yet another certain implementation of the present disclosure additionally provides a natural sweetener composition that tastes like sugar and is diabetic safe.

It is particularly desirable in the production of sweeteners and sugar substitutes to develop sweeteners and sweetener compositions that are as similar as possible to sugar in texture, taste, and usability. More specifically, development of sweeteners and sweetener compositions that provide an appropriate level of sweetness, have an appropriate texture and mouthfeel, have a positive impact on product appearance, have limited or no negative aftertaste, and provide flavor enhancing and/or masking abilities and stability, is particularly desirable. However, due to the varying properties of different sweetening ingredients achieving a satisfactory result when combining such ingredients is often difficult. The difficulty is generally believed to be due to the synergistic effects of mixing various sweetening compounds wherein the sweetness of the mixture is often greater than the apparent sweetness of the individual components. An appropriate blend of beet sugar derived isomaltulose, beet sugar and monk fruit extract can result in a sweetener product that has many of the desirable properties of sugar without the greatest liabilities of sugar—a high caloric and glycemic load. Additionally, an appropriate blend of beet sugar derived isomaltulose and monk fruit extract can result in a sweetener product that has many of the desirable properties of sugar without the greatest liabilities of sugar; a high caloric, glycemic and carbohydrate load.

Further, in accordance with an implementation of the present disclosure, a natural sweetener composition for the primary use in beverages and food products where the taste and qualities of cane sugar are nearly identical, however, at two times the sweetness of cane sugar, offers greater cost efficiency, includes an appropriate blend of a beet sugar derived isomaltulose, beet sugar and monk fruit extract can result in sweetener product that has many of the desirable properties of sugar without the added calories. In particular, the natural sweetener composition includes beet sugar derived isomaltulose, beet sugar and monk fruit extract. In particular, the natural sweetener composition includes: about 40 to about 90 composition weight percent of beet sugar derived isomaltulose, about 10 to about 50 composition weight percent beet sugar and about 1 to about 10 composition weight percent of monk fruit extract.

Preferably, the natural sweetener composition may include additional ingredients, compounds or sweeteners which may enhance the flavor, stability, and processability of the sweetener composition. For example, the natural sweetener composition may include an additional sweetener such as a reduced-calorie sweetener, a sugar-derived sweetener, or a non-nutritive sweetener. Additionally, the natural sweetener composition may include a processing and/or stability aids such as, for example, silica and or other flow or preservative agents.

### Example 1: Natural Sweetener Composition

| | Composition Weight | Single Serving |
|---|---|---|
| Ingredient | Percent | Weight (g) |
| Beet sugar derived | 71.4 | 0.71435 |
| isomaltulose | | |
| Beet sugar | 25.0 | 0.25 |
| Monk Fruit Extract | 3.6 | 0.036 |

In accordance with certain implementations of the present disclosure, a natural sweetener composition for use in beverages and/or food products includes beet sugar derived isomaltulose, beet sugar and monk fruit extract. In particular, the natural sweetener composition may include:
about 55 to about 90 composition weight percent of beet sugar derived isomaltulose;
about 10 to about 50 composition weight percent of beet sugar; and
about 1 to about 10 composition weight percent of monk fruit extract.

Some implementations consist of beet sugar derived isomaltulose, beet sugar and monk fruit extract. Some implementations consist essentially of beet sugar derived isomaltulose, beet sugar and monk fruit extract, wherein silica, nutritional supplement and/or flavoring do not materially affect the basic and novel characteristic(s) of the claimed invention.

Further, in accordance with another implementation of the present disclosure, a natural sweetener composition for the primary use in beverages and food products where the taste and qualities of cane sugar are nearly identical, such as beet sugar derived isomaltulose and monk fruit extract. In particular, the natural sweetener composition includes: about 90 to about 99 composition weight percent of beet sugar derived isomaltulose and about 1 to about 10 composition weight percent of monk fruit extract.

### Example 2: Natural Sweetener Composition

| | Composition Weight | Single Serving |
|---|---|---|
| Ingredient | Percent | Weight (g) |
| Beet sugar derived | 97.3 | 0.973 |
| isomaltulose | | |
| Monk Fruit Extract | 2.7 | 0.27 |

In another implementation, the natural sweetener composition may include:
about 90 to about 99 composition weight percent of beet sugar derived isomaltulose; and
about 1 to about 10 composition weight percent of monk fruit extract.

Preferably, the natural sweetener composition may include additional ingredients, compounds or sweeteners which may enhance the flavor, stability, and processability of the sweetener composition. For example, the all-natural sweetener composition may include an additional sweetener such as a reduced-calorie sweetener, a sugar-derived sweetener, or a non-nutritive sweetener. Additionally, the natural sweetener composition may include a processing and/or stability aids such as, for example, silica and or other flow or preservative agents.

Some implementations consist of beet sugar derived isomaltulose and monk fruit extract. Some implementations consist essentially of beet sugar derived isomaltulose and monk fruit extract, wherein silica, nutritional supplement and/or flavoring do not materially affect the basic and novel characteristic(s) of the claimed invention.

Further, in accordance with certain preferred implementations of the present disclosure, a natural sweetener composition for the primary use in commercial food and beverage product applications where the taste and qualities of cane sugar are nearly identical, however, at two times the sweetness of cane sugar, offers greater cost efficiency, includes an appropriate blend of a beet sugar derived isomaltulose, beet sugar and monk fruit extract can result in sweetener product that has many of the desirable properties of sugar without the added calories.

While in the foregoing specification this disclosure has been described in relation to certain preferred implementations thereof, and many details have been set forth for purposes of illustration, it will be apparent to those skilled in the art that the natural sweetener composition according to this disclosure is susceptible to additional implementations and that certain of the details described herein can be varied significantly without departing from the basic principles of the disclosure.

### Special Blending Protocol in the Manufacturing Process

To achieve the full benefit of the sweetness level intended and for all of characteristics to be fully realized for these products that the smallest amount ingredient be mixed with the next larger amount until fully blended. Then the next largest ingredient is then added to the combined blend until the next largest ingredient is fully dispersed. Then the next largest ingredient is added after that, and this protocol is continued until all ingredients are blended. This assures maximum dispersion of all elements.

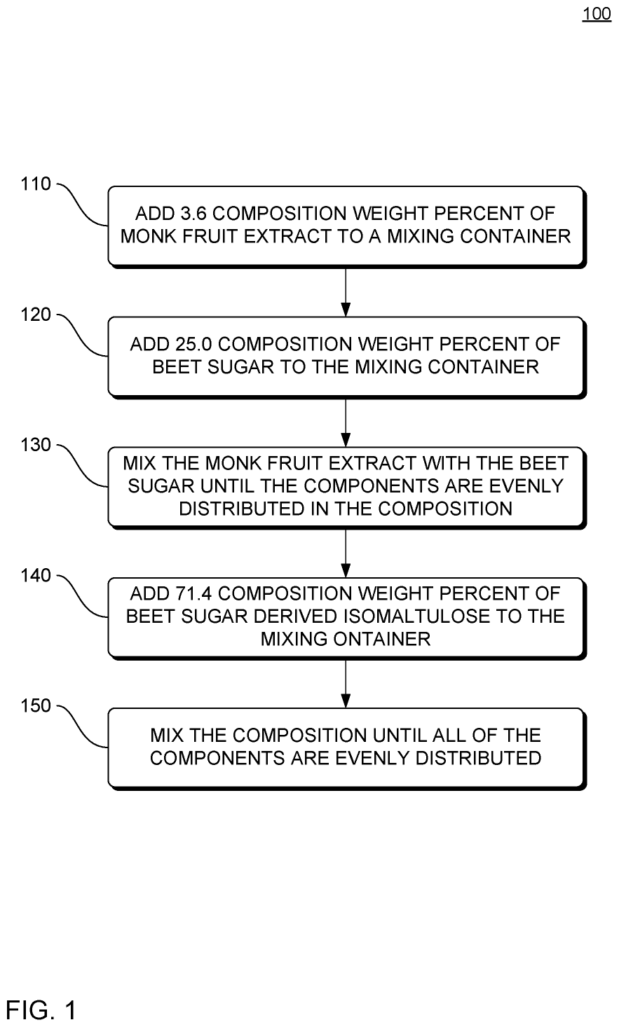

FIG. 1 shows exemplary flowchart 100 illustrating the blending of a natural sweetener, according to one implementation of the present disclosure. At block 110, 3.6 composition weight percent Monk Fruit extract is added to a mixing container, such as a mixing bowl. At block 120, 25.0 composition weight percent of beet sugar is added to the mixing container. At block 130, the Monk Fruit extract and beet sugar are mixed together until they are evenly distributed in the composition. At block 140, 71.4 composition weight percent of beet sugar derived isomaltulose is added to the mixing container. At block 150, the composition is mixed until the Monk Fruit extract, the beet sugar, and the beet sugar derived isomaltulose are evenly distributed in the composition.

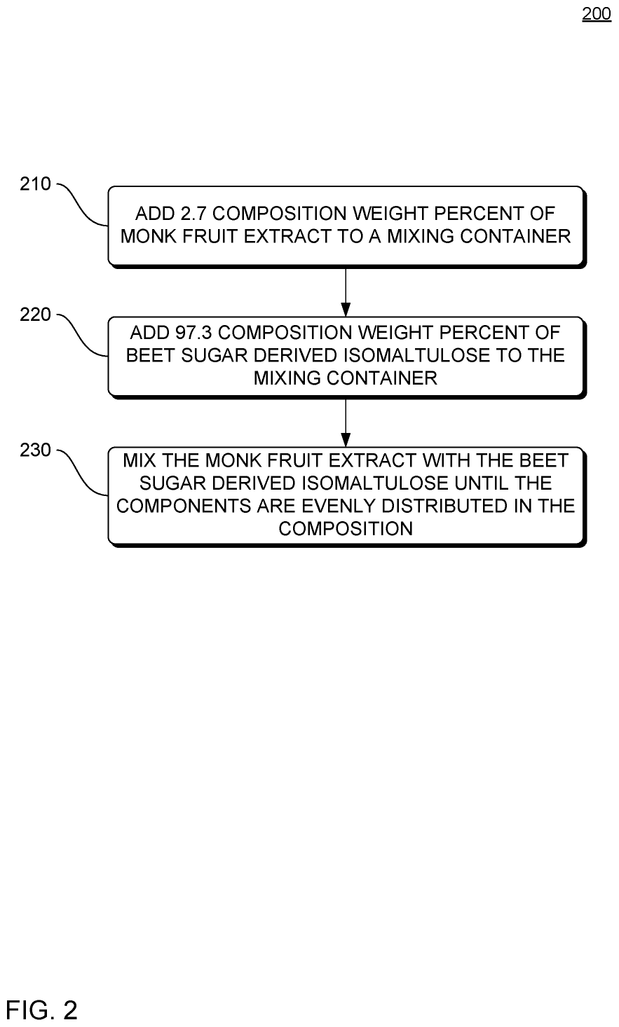

FIG. 2 shows exemplary flowchart 200 illustrating the blending of a natural sweetener, according to one implementation of the present disclosure. At block 210, 2.7 composition weight percent Monk Fruit extract is added to a mixing container, such as a mixing bowl. At block 220, 97.3 composition weight percent of beet sugar derived isomaltulose is added to the mixing container. At block 230, the composition is mixed until the Monk Fruit extract and the beet sugar derived isomaltulose are evenly distributed in the composition.

While in the foregoing specification this disclosure has been described in relation to certain preferred implementations thereof, and many details have been set forth for purposes of illustration, it will be apparent to those skilled in the art that the natural sweetener composition according to this disclosure is susceptible to additional implementations and that certain of the details described herein can be varied significantly without departing from the basic principles of the disclosure.

1. A process comprising:
adding 3.6 composition weight percent of a monk fruit extract;
adding 25.0 composition weight percent of a beet sugar;
mixing the monk fruit extract with the beet sugar until the monk fruit extract with the beet sugar are evenly distributed;
adding 71.4 composition weight percent of beet sugar derived isomaltulose; and
mixing the monk fruit extract, the beet sugar and beet sugar derived isomaltulose until even distribution is achieved.

2. A process comprising:
adding 2.7 composition weight percent of monk fruit extract to a mixing container;
adding 97.3 composition weight percent of beet sugar derived isomaltulose to the mixing container; and
mixing the monk fruit extract and the beet sugar derived isomaltulose until the monk fruit and the beet sugar derived isomaltulose are evenly distributed.

3. A composition consisting essentially of beet sugar derived isomaltulose and monk fruit extract.

4. A composition consisting essentially of beet sugar derived isomaltulose, beet sugar and monk fruit extract.
